(19) United States
(12) Patent Application Publication
(10) Pub. No.: US 2016/0018764 A1
(43) Pub. Date: Jan. 21, 2016

(54) FIXING APPARATUS

(71) Applicant: CANON KABUSHIKI KAISHA, Tokyo (JP)

(72) Inventors: Kenji Takagi, Odawara-shi (JP); Masato Sako, Susono-shi (JP)

(21) Appl. No.: 14/800,506

(22) Filed: Jul. 15, 2015

(30) Foreign Application Priority Data
Jul. 18, 2014 (JP) 2014-148109

(51) Int. Cl. G03G 15/20

(52) U.S. Cl. CPC G03G 15/205

(57) ABSTRACT

A fixing apparatus includes a cylindrical film, a heater including a substrate, a first heat generation resistor formed on a first surface of the substrate which is a surface facing an inner surface of the film, and a second heat generation resistor formed on a second surface opposite to the first surface, and a control portion, wherein during a time period from the start of warm-up of the fixing apparatus to a predetermined time, the control portion is configured either to supply power to the first heat generation resistor while supplying no power to the second heat generation resistor or to supply power to the first heat generation resistor and the second heat generation resistor such that the power supplied to the first heat generation resistor is higher than the power supplied to the second heat generation resistor.

### BACKGROUND OF THE INVENTION

1. Field of the Invention

The present invention relates to a fixing apparatus mounted on image forming apparatuses such as electrophotographic copying machines, or electrophotographic printers.

2. Description of the Related Art

Fixing apparatuses using a cylindrical film with excellent on-demand properties are widely employed as fixing apparatuses mounted on image forming apparatuses such as copying machines, laser beam printers, etc.

Such a fixing apparatus generally includes a cylindrical film, a plate-type heater in contact with an inner surface of the film, and a back-up member forming a nip portion together with the heater via the film. While a recording material on which a toner image is formed is conveyed through the nip portion, the toner image is heated and fixed to the recording material.

The heater used in the fixing apparatus includes a substrate made of a ceramic material, such as aluminum oxide, or aluminum nitride, a heat generation resistor formed on the substrate, and an insulation layer which is, for example, made of glass and covers the heat generation resistor.

Among the heaters, a known heater includes heat generation resistors to which power can be independently supplied. The heat generation resistors are formed on front and back surfaces of a substrate and selectively used according to the size of a recording material, etc. (Japanese Patent Application Laid-Open No. 2003-337484).

A heater including heat generation resistors formed on the front and back surfaces of the substrate has the following problem. In a case where the heat generation resistor on the surface of the substrate (hereinafter “front surface”) that is in contact with an inner surface of a film is heated, since there is only the film between the heater and the recording material, the heat from the heater quickly transfers to the recording material. On the other hand, in a case where the heat generation resistor on the surface of the substrate that is opposite to the front surface (hereinafter “back surface”) is heated, since there is not only the film but also the substrate between the heater and the recording material, the transfer of the heat from the heater is slower than in the case where the heat generation resistor on the front surface of the substrate is heated.

Table 1 illustrates the heat transfer times for each of aluminum nitride and aluminum oxide, which are used as a substrate material. The heat transfer time is calculated based on a thermo-physical property according to the time needed for heat to transfer a distance of 1 mm. In the case where the heat generation resistor on the back surface of the substrate is heated, the transfer of the heat generated by the heater to the recording material is slower than specified in Table 1 where the resistor on the front surface is heated.

TABLE 1

| Substrate material | Heat transfer time [msec] |
|---|---|
| Aluminum nitride | 31.3 |
| Aluminum oxide | 105.3 |

The heat transfer time affects especially the warm-up time of the fixing apparatus. The warm-up time is longer in a case of supplying power to the heat generation resistor on the back surface of the substrate to start the warm-up than in a case of supplying power to the heat generation resistor on the front surface of the substrate to start the warm-up. Thus, in the case where the heat generation resistors on the front and back surfaces of the substrate are selectively used according to the size of the recording material as discussed in Japanese Patent Application Laid-Open No. 2003-337484, the warm-up time varies depending on the size of the recording material.

### SUMMARY OF THE INVENTION

According to an aspect of the present invention, a fixing apparatus configured to fix a toner image to a recording material includes a cylindrical film, a heater arranged to contact an inner surface of the film, the heater including a substrate, a first heat generation resistor formed on a first surface of the substrate which is a surface facing the inner surface of the film, and a second heat generation resistor formed on a second surface of the substrate which is a surface opposite to the first surface, a back-up member contacting the film to form a pressure contact portion, and a control unit configured to control the power supply to the heater so as to supply power to the first heat generation resistor and to the second heat generation resistor independently, wherein a recording material is heated by heat of the film to fix the toner image to the recording material, and wherein during a time period from the start of warm-up of the fixing apparatus to a predetermined time, the control unit is configured either to supply power to the first heat generation resistor while supplying no power to the second heat generation resistor or to supply power to the first heat generation resistor and the second heat generation resistor such that the power supplied to the first heat generation resistor is higher than the power supplied to the second heat generation resistor.

According to another aspect of the present invention, a fixing apparatus configured to fix a toner image to a recording material includes a cylindrical film, a heater arranged to contact an inner surface of the film and including a substrate, first and second heat generation resistors formed on a first surface of the substrate which is a surface facing the inner surface of the film, and a third heat generation resistor formed on a second surface of the substrate which is a surface opposite to the first surface, a back-up member contacting the film to form a pressure contact portion, and a control portion configured to control the power supply to the heater so as to supply power to the first heat generation resistor, to the second heat generation resistor, and to the third heat generation resistor independently, wherein a recording material is heated by heat of the film to fix the toner image to the recording material, and wherein during a time period from a start of warm-up of the fixing apparatus to a predetermined time, the control portion is configured either to supply power to at least one of the first heat generation resistor and the second heat generation resistor while supplying no power to the third heat generation resistor, or control to supply power to the first heat generation resistor, the second heat generation resistor, and the third heat generation resistor such that a total of the power supplied to the first heat generation resistor and the power supplied to the second heat generation resistor is higher than the power supplied to the third heat generation resistor.

Further features of the present invention will become apparent from the following description of exemplary embodiments with reference to the attached drawings.

### BRIEF DESCRIPTION OF THE DRAWINGS

FIG. 1 is a schematic cross sectional view illustrating an image forming apparatus according to an exemplary embodiment.

FIG. 2 is a transverse cross sectional view illustrating a fixing apparatus according to a first exemplary embodiment.

FIGS. 3A, 3B, 3C, and 3D illustrate a schematic configuration of a heater according to the first exemplary embodiment.

FIG. 4A is a flow chart illustrating power control according to the first exemplary embodiment, and FIG. 4B is a flow chart illustrating power control according to a comparative example.

FIG. 5A is a pattern diagram illustrating temporal changes in maximum power according to the first exemplary embodiment, and FIG. 5B is a pattern diagram illustrating temporal changes in maximum power according to the comparative example.

FIGS. 6A, 6B, and 6C are pattern diagrams illustrating temperature changes according to the first exemplary embodiment and the comparative example.

FIGS. 7A, 7B, and 7C are pattern diagrams illustrating temporal changes in power according to first and second modified examples.

FIG. 8 is a transverse cross sectional view illustrating a fixing apparatus using a pressure belt unit.

FIG. 9 is a transverse cross sectional view illustrating a fixing apparatus using an external heating/fixing method.

FIGS. 10A, 10B, 10C, and 10D illustrate a schematic configuration of a heater according to a second exemplary embodiment.

FIG. 11 is a flow chart illustrating power control according to the second exemplary embodiment.

FIG. 12 is a pattern diagram illustrating temporal changes in maximum power according to the second exemplary embodiment.

### DESCRIPTION OF THE EMBODIMENTS

The following describes a first exemplary embodiment of the present invention. Exemplary embodiments of the present invention will be described in detail below with reference to the drawings. Each of the embodiments of the present invention described below can be implemented solely or as a combination of a plurality of the embodiments or features thereof where necessary or where the combination of elements or features from individual embodiments in a single embodiment is beneficial.

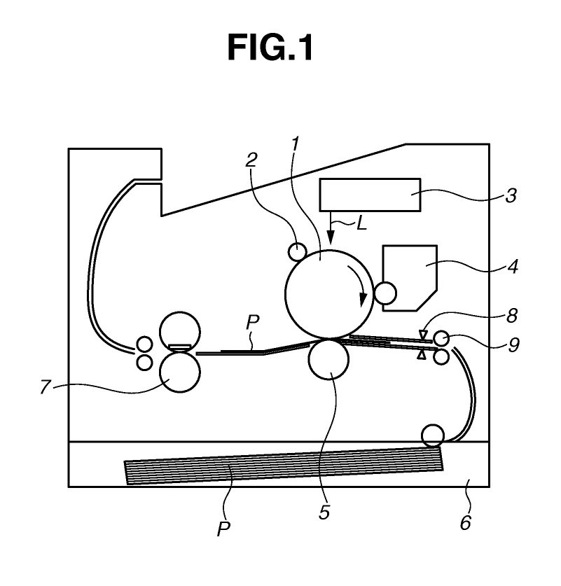

FIG. 1 illustrates a schematic configuration of a laser beam printer, which is an example of an image forming apparatus according to the present exemplary embodiment. The laser beam printer includes a photosensitive drum 1. The photosensitive drum 1 is driven to rotate in a direction specified by an arrow. First, the surface of the photosensitive drum 1 is uniformly charged by a charging roller 2, which is a charging device. Next, a laser scanner 3 scan-exposes the surface to a laser beam L on which on/off control is performed according to image information, and an electrostatic latent image is formed. Then, a development device 4 applies toner to the electrostatic latent image to develop a toner image on the photosensitive drum 1. Thereafter, the toner image formed on the photosensitive drum 1 is transferred onto a recording material P, which is conveyed from a sheet feeding cassette 6 at a predetermined timing, at a transfer nip portion formed by a transfer roller 5 and the photosensitive drum 1. At this time, a leading edge of the recording material P conveyed by a conveyor roller 9 is detected by a top sensor 8 to synchronize the timing so that a position in the leading edge of the recording material from which the writing is started is aligned with a position on the photosensitive drum 1 in which the toner image is formed. The recording material P conveyed to the transfer nip portion at the predetermined timing is pinched and conveyed by the transfer nip portion. The recording material P onto which the toner image is transferred is conveyed to a fixing apparatus 7, and the toner image is heated and fixed onto the recording material by the fixing apparatus 7. Thereafter, the recording material P is discharged onto a sheet discharge tray.

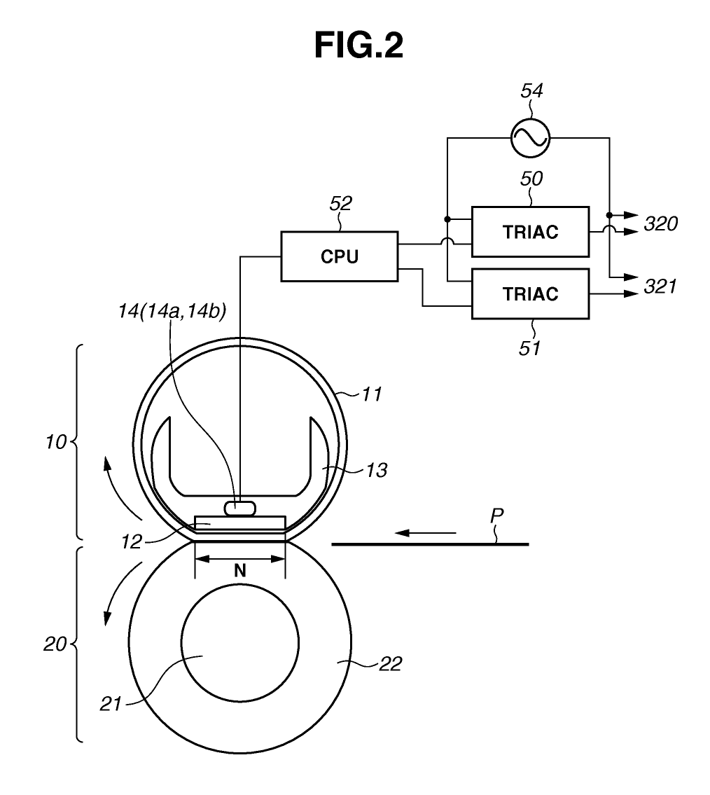

The following describes the fixing apparatus 7 according to the present exemplary embodiment. FIG. 2 is a cross sectional view of the fixing apparatus 7. The fixing apparatus 7 includes a cylindrical film 11, a heater 12 in contact with an inner surface of the film 11, and a pressure roller 20. The pressure roller 20 is a back-up member that is in contact with the film 11 to form a pressure contact portion. The pressure contact portion is a nip portion N configured to convey the recording material P. The heater 12 forms the nip portion N together with the pressure roller 20 via the film 11. While the nip portion N is conveying the recording material P on which the toner image is formed, the toner image is fixed by heating onto the recording material P.

The film 11 has a total thickness of 80 μm to enable a quick start. The film 11 includes a base layer and a release layer outside the base layer. A heat-resistant resin such as polyimide, polyamide-imide, polyether ether ketone (PEEK) can be used as a material of the base layer. According to the present exemplary embodiment, polyimide having a thickness of 65 μm is used. Further, a heat-resistant resin with excellent release property, such as a fluorine resin including polytetrafluoroethylene (PTFE), perfluoroalkoxy alkane (PFA), and fluorinated ethylene propylene (FEP) or a silicone resin, etc., can be used singly or in combination as a material of the release layer to form a coating. According to the present exemplary embodiment, a coating of fluorine resin PFA having a thickness of 15 μm is used.

The film 11 according to the present exemplary embodiment has a length of 240 mm in a generatrix direction to handle a letter size (width 216 mm), and an outer diameter of 24 mm.

A film guide 13 is in contact with an inner surface of the film 11 to guide the rotation of the film 11. The film 11 is loosely and externally fit onto the film guide 13 and freely rotatable in the direction of an arrow. Further, the film guide 13 also has a function of supporting the surface of the heater 12 that is opposite to the surface in contact with the film 11. The film guide 13 is made of a material such as a liquid crystal polymer, phenolic resin, polyphenylenesulfide (PPS), PEEK. The film 11, the heater 12, and the film guide 13 are assembled to form a film unit 10.

The pressure roller 20 includes a core metal 21 and a rubber layer 22 formed outside the core metal 21. The core metal 21 is made of a metal such as stainless steel (SUS), steel use machinability (SUM), aluminum (Al). The rubber layer 22 is made of a heat-resistant rubber such as a silicone rubber, fluorine rubber, or a foamed rubber produced by foaming a silicone rubber. Further, a release layer such as PFA, PTFE, FEP, etc. may be formed outside the rubber layer 22. The pressure roller 20 according to the present exemplary embodiment has an outer diameter of 25 mm and uses a silicone rubber in a thickness of 3.5 mm as the rubber layer. Further, the length of the rubber layer in the lengthwise direction is 230 mm.

The film unit 10 is pressed against the pressure roller 20 in the direction in which the heater 12 faces the pressure roller 20, and thus, the nip portion N is formed. Further, the driving power is transmitted from a driving source (not illustrated) to a driving member (not illustrated) provided in an end portion of the core metal 21 of the pressure roller 20 in the lengthwise direction, so that the pressure roller 20 is rotated. The film 11 receives frictional force from the rotating pressure roller 20 at the nip portion N and rotates following the rotation of the pressure roller 20.

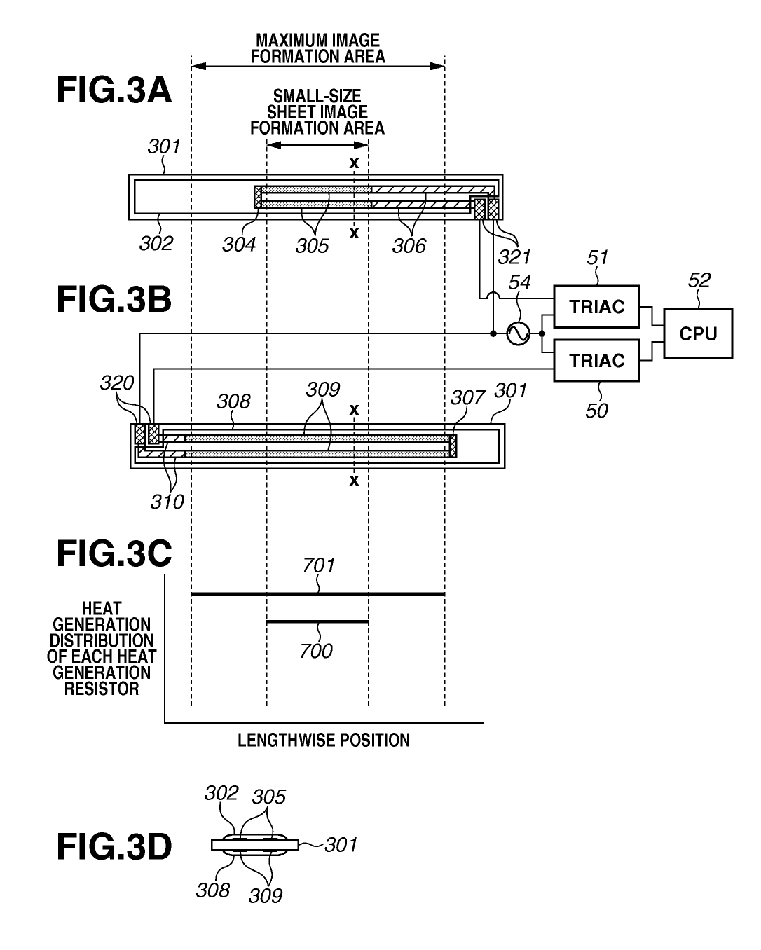

As illustrated in FIGS. 3A, 3B, 3C, and 3D, the heater 12 includes a long, thin substrate 301, heat generation resistors (305, 309) formed on front and back surfaces of the substrate 301, and protective layers (302, 308) covering the heat generation resistors (305, 309). The heat generation resistor 309 is formed on a first surface of the substrate 301. The first surface is in contact with the inner surface of the film 11. The heat generation resistor 305 is formed on a second surface of the substrate 301. The second surface is opposite to the first surface. FIG. 3B is a schematic view illustrating the first surface of the heater 12 according to the present exemplary embodiment. FIG. 3A is a schematic view illustrating the second surface of the heater 12. FIG. 3D is a schematic view of the heater 12 along the x-x′ cross section specified in FIGS. 3A and 3B.

The following describes the structure of the first surface of the heater 12, with reference to FIG. 3B. The substrate 301 is made of a ceramic material such as aluminum oxide (Al₂O₃), aluminum nitride (AlN). According to the present exemplary embodiment, the substrate 301 is made of Al₂O₃ and has a width of 10 mm, a length of 270 mm in the lengthwise direction, and a thickness of 1 mm. The heat generation resistor 309 is formed on the first surface of the substrate 301 as a first heat generation resistor. The heat generation resistor 309 is formed by screen printing using a material such as silver/palladium (Ag/Pd) having a thickness of about 10 μm on the first surface of the substrate 301. Two heat generation resistors each having a length of 225 mm and a width of 1.5 mm are arranged alongside with a space of 3.0 mm in the widthwise direction of the substrate 301, and thus forming the heat generation resistor 309. The heat generation resistor 309 is formed by electrically connecting one end portions of the two heat generation resistors with a conductor 307 to connect the two heat generation resistors in series. According to the present exemplary embodiment, the resistance value of the heat generation resistor 309 is 12Ω. The length of the heat generation resistor 309 in the lengthwise direction of the substrate 301 is set to 225 mm so that a toner image formed on a letter size (216 mm width) or A4 size (210 mm width) recording material can be processed, which is a material with a maximum width conveyable by the apparatus according to the present exemplary embodiment. More specifically, the heat generation resistor 309 is adaptable to a large size recording material. Further, a conductor 310 supplies power to the heat generation resistor 309, and a power feeding contact point 320 as a connector point for the supply of electric current. The conductors 307 and 310 and the power feeding contact point unit 320 are made of a material having a lower resistance value than the resistance value of the heat generation resistor 309. According to the present exemplary embodiment, the conductors 307 and 310 and the power feeding contact point unit 320 are formed by screen printing using a paste containing mixed powder of Ag (silver) and Pt (platinum). The heat generation resistor 309 is coated with the protective layer 308. The protective layer 308 includes a glass coating layer having a thickness of 65 μm to ensure insulation property and wear-resistant property with respect to the film.

The following describes the structure of the second surface of the heater 12, with reference to FIG. 3A. On the second surface of the substrate 301 is formed the heat generation resistor 305 as a second heat generation resistor. Similar to the heat generation resistor 309, the heat generation resistor 305 is formed by screen printing on the second surface of the substrate 301. Two heat generation resistors each having a length of 115 mm and a width of 1.5 mm are arranged side-by-side keeping a space of 3.0 mm in the widthwise direction of the substrate 301, and thus forming the heat generation resistor pattern 305. The heat generation resistor 305 is formed by electrically connecting one end portions of the two heat generation resistors with a conductor 304 to connect the two heat generation resistors in series. According to the present exemplary embodiment, the resistance value of the heat generation resistor 305 is 25Ω. The length of the heat generation resistor 305 in the lengthwise direction of the substrate 301 is set to 115 mm so that a toner image formed on a small-size recording material, such as an official postal card (100 mm width), A6 size sheet (105 mm width), etc., can be processed. More specifically, the heat generation resistor 305 is adaptable to a small-size recording material.

A conductor 306 supplies power to the heat generation resistor 305, and a power feeding contact point 321 where a connector contact point for the power supply is brought into contact. According to the present exemplary embodiment, the conductors 304 and 306 and the power feeding contact point unit 321 are formed by screen printing using a paste containing mixed powder of Ag (silver) and Pt (platinum). Similar to the protective layer 308, the protective layer 302 is a layer including a glass coating layer having a thickness of 65 μm.

FIG. 3C illustrates heat generation distributions of the heat generation resistor 309 on the first surface of the heater 12 and the heat generation resistor 305 on the second surface in the lengthwise direction. A heat generation distribution 701 of the heat generation resistor 309 and a heat generation distribution 700 of the heat generation resistor 305 are uniform in the lengthwise direction, although the lengths of heat generation areas are different.

The following describes a process of fixing a toner image onto a recording material by heating while conveying the recording material at the nip portion. When the heater 12 has reached a predetermined temperature after the pressure roller 20 is driven to rotate and power is supplied to the heat generation resistor of the heater 12, a recording material P bearing an unfixed toner image is introduced to the nip portion N with the toner-image-bearing surface facing the film 11. At the nip unit N, the recording material P is pinched and conveyed by a surface of the film 11 and a surface of the pressure roller 20. During the convey process at the nip portion N, the toner image on the recording material P is heated and melted via the film 11 by heat generated by the heat generation resistor of the heat 12 and fixed onto the recording material P by pressure applied by the nip portion N. Then, the recording material P onto which the toner image is fixed by the heating is discharged from the nip portion N.

The following describes power control of the heater 12. The control of the heater 12 is performed by controlling the power supply to the heater 12 so as to bring the temperature detected by a main thermistor 14a to a target temperature. The main thermistor 14a is a temperature detection member provided at a central portion of the heater 12 in the lengthwise direction. An output signal of the main thermistor 14a is input to a central processing unit (CPU) 52 serving as a control unit including a CPU and a memory such as a read-only memory (ROM), a random access memory (RAM), etc. Based on the input signal, the CPU 52 controls the power supply to the heat generation resistors 305 and 309 of the heater 12 via triacs 50 and 51 so as to maintain the temperature detected by the heater 12 at the target temperature. The control of the power supply to the heat generation resistors 305 and 309 is performed by turning the alternate current (AC) voltage supply on and off using the triacs. A sub-thermistor 14b disposed on the second surface of the heater 12 is provided at a non-sheet-passing portion of the heater 12 through which no A4 size recording material is passed. The sub-thermistor 14b functions as a safety device. More specifically, the sub-thermistor 14b detects the temperature at an end portion of the heater 12 and monitors the temperature of the film 11 to prevent the temperature of the film 11 from exceeding an upper limit temperature of the film 11.

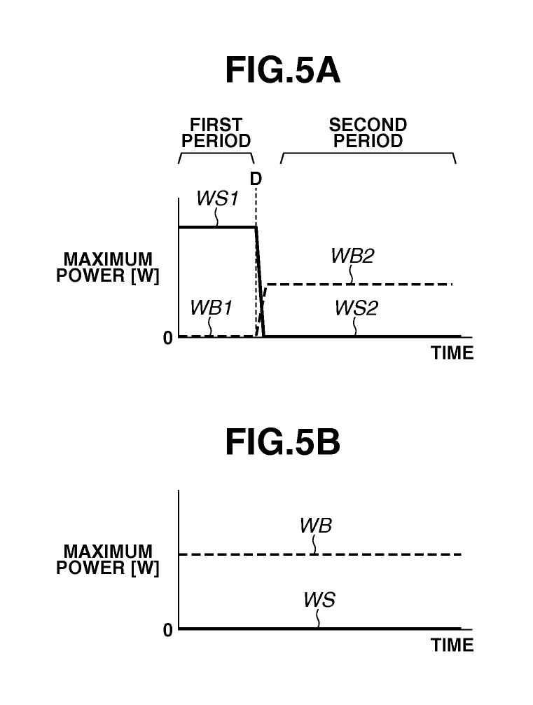

The following describes the power control of the power supply to the heat generation resistors (305, 309) of the heater 12, which is a feature of the present exemplary embodiment. First, the power control will be described below which is performed in a case where the fixing process is carried out for a small-size recording material having a width of 110 mm or less. Table 2 shows the maximum power supplied to each of the heat generation resistor 305 and 309 in a first period and in a second period. The first period is a time from the start of the power supply to the heater 12 to a predetermined timing (D). The second period is a time following the first period. Further, FIG. 5A illustrates how the maximum power supplied to each of the heat generation resistor 305 and 309 is changed from the first period to the second period. The first period can also be defined as a period from the start of warm-up of the fixing apparatus to the predetermined timing (D). Further, in general, the power consumption of the image forming apparatus needs to be equal to or lower than the rated value of a power source being used. Thus, in the image forming apparatus according to the present exemplary embodiment, the maximum power that can be supplied to the heater 12 is set to 850 W at a voltage of 100 V. Accordingly, if the maximum power that can be supplied to the heat generation resistor 305 (maximum of about 400 W at 100 V) and the maximum power that can be supplied to the heat generation resistor 309 (maximum of about 833 W at 100 V) are simultaneously supplied to the heat generation resistors 305 and 309, the power consumption exceeds the rated power. Thus, according to the present exemplary embodiment, even in the case of performing the fixing process on a small-size recording material having a width of 110 mm or less in the first period, first power control is performed to supply power only to the heat generation resistor 309 formed on the first surface close to the inner surface of the film 11. The first power control is performed to supply concentrated power only to the heat generation resistor 309 contacting the inner surface of the film 11 in the first period in which the components of the fixing apparatus such as the film 11 are probably not yet warmed up. As a result, the film 11 is rapidly warmed up. The first power control in the first period produces an effect that the warm-up time of the fixing apparatus is shortened. Then, in the second period started following the first period, second power control is performed to supply power only to the heat generation resistor 305 formed on the second surface of the heater 12. Only the heat generation resistor 305 corresponding to the size of a small-size recording material is heated to heat up the film 11 after the film 11 has been warmed up in the first period. Thus, an increase in the temperature of the non-sheet-passing portion is prevented. Accordingly, as illustrated in FIG. 5A, in the case of performing the fixing process on a recording material having a width of 110 mm or less, the maximum power (WB1) supplied to the heat generation resistor 305 in the first period is zero, and the maximum power (WB2) supplied to the heat generation resistor 309 in the second period is zero. Supplying zero power to the heat generation resistor means that no power is supplied. More specifically, the first control is configured to supply power to the heat generation resistor 309 while supplying no power to the heat generation resistor 305. Further, the second control is configured to supply power to the heat generation resistor 305 while supplying no power to the heat generation resistor 309.

On the other hand, in a case of performing the fixing process on a recording material having a greater width than 110 mm, the first power control is performed from the start of the power supply to the heater 12 to the end of the fixing process.

TABLE 2

| | First period | Second period |
|---|---|---|
| Maximum power supplied to heat | WS1 (833 W) | WS2 (0 W) |
| generation resistor 309 | | |
| Maximum power supplied to heat | WB1 (0 W) | WB2 (400 W) |
| generation resistor 305 | | |

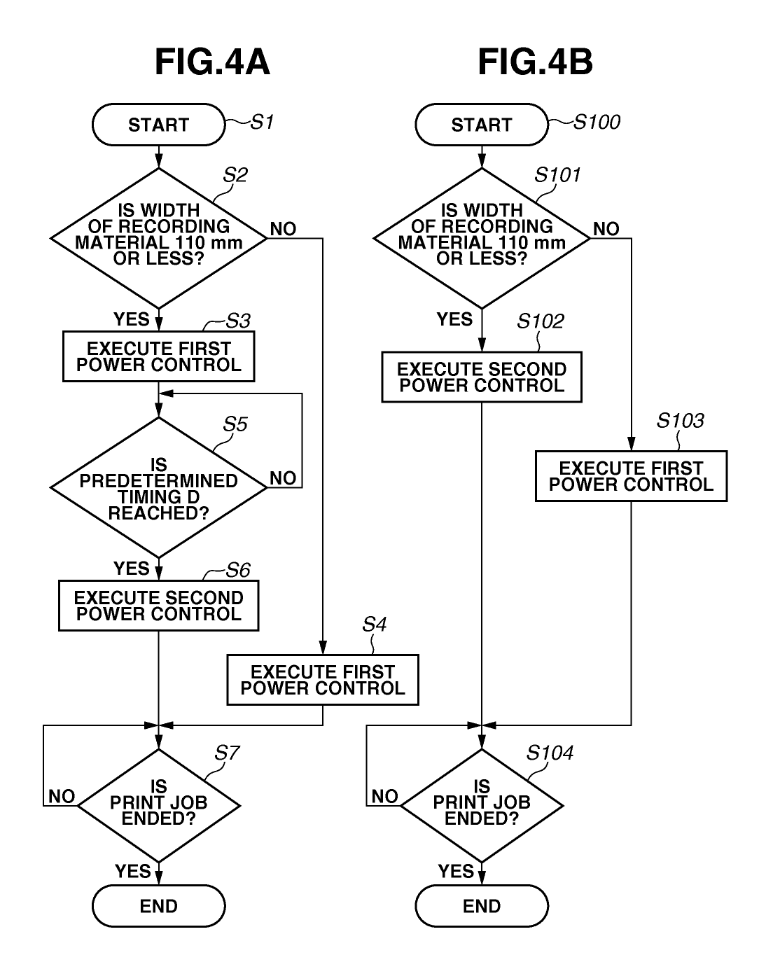

Next, FIG. 4A is a flow chart illustrating the power control according to the present exemplary embodiment. First, in step S1, a print job is started. In step S2, it is determined whether the recording material is a small-size recording material having a width of 110 mm or less in the direction orthogonal to the direction in which the recording material is conveyed. In step S2, if it is determined that the width of the recording material is 110 mm or less (YES in step S2), then in step S3, the first power control is executed in the first period. Then, in step S5, if the predetermined timing D has been reached (YES in step S5), then in step S6, the second power control is executed in the second period. In step S7, the print job is ended. On the other hand, in step S2, if it is determined that the width of the recording material exceeds 110 mm (NO in step S2), then in step S4, the first power control is executed. Then, in step S7, the print job is ended. Further, according to the present exemplary embodiment, the predetermined timing D is a point at which the temperature which the sub-thermistor 14b detects reaches a predetermined temperature. More specifically, the first period shifts to the second period when the temperature of the non-sheet-passing portion starts gradually increasing as a result of continuous printing on the recording materials P and the heater 12 and the fixing apparatus 7 are entirely warmed up.

The following describes advantages of the present exemplary embodiment in comparison with a comparative example. The structure of a fixing apparatus according to the comparative example is similar to that of the present exemplary embodiment, and only the power control on the heater 12 is different. FIG. 4B is a flow chart illustrating power control according to the comparative example. In step S100, a print job is started. In step S101, it is determined whether the width of the recording material in a direction orthogonal to the direction in which the recording material is conveyed is 110 mm or less. In step S101, if it is determined that the width of the recording material is 110 mm or less (YES in step S101), then in step S102, the second power control is executed to supply power only to the heat generation resistor 305. Then, in step S104, the print job is ended. On the other hand, in step S101, if it is determined that the width of the recording material exceeds 110 mm (NO in step S101), then in step S103, the first power control is executed to supply power only to the heat generation resistor 309. Then, in step S104, the print job is ended. Further, FIG. 5B illustrates changes in maximum power supplied to each of the heat generation resistors 309 and 305 according to the comparative example. As illustrated in FIG. 5B, in the case where the width of the recording material on which the fixing process is performed in the comparative example is 110 mm or less, the maximum power supplied to each of the heat generation resistor 305 and 309 during the period from the start of the power supply to the heater 12 to the end of the fixing process are as follows. The maximum power WB supplied to the heat generation resistor 305 is not zero, whereas the maximum power WS supplied to the heat generation resistor 309 is zero.

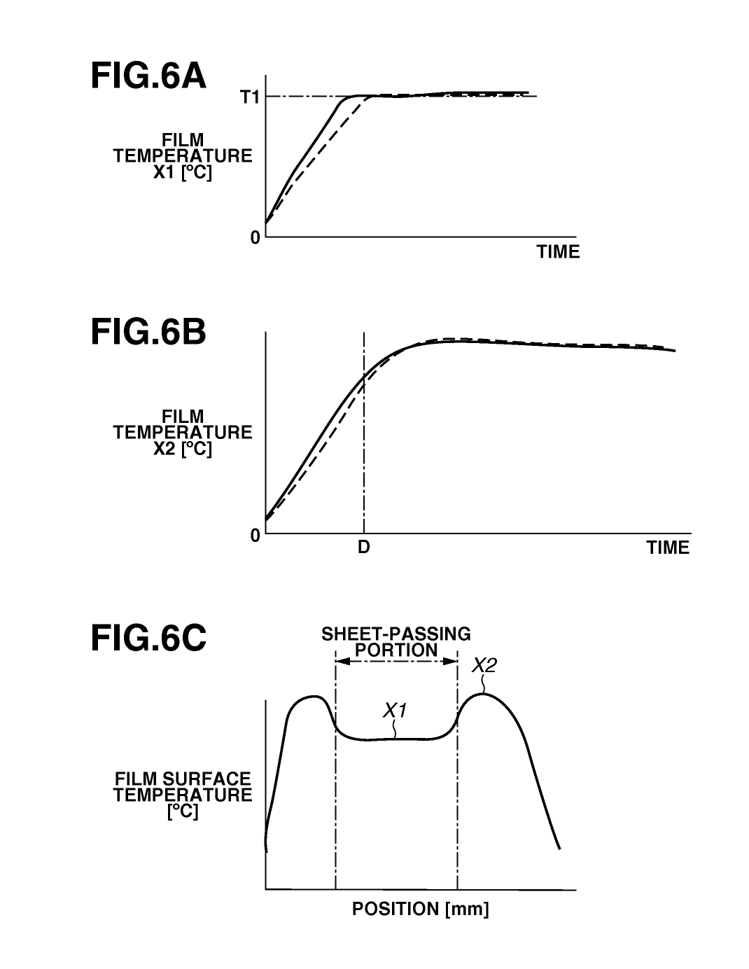

FIGS. 6A, 6B, and 6C illustrate the following items in the case of printing on a small-size recording material (A6 size: width 105 mm) with the image forming apparatus according to the present exemplary embodiment. FIG. 6A illustrates temporal changes in the temperature of a sheet passing portion on the film surface during the warm-up period of the fixing apparatus, and FIG. 6B illustrates temporal changes in the temperature of the non-sheet-passing portion on the film surface during the continuous execution of the fixing process. Further, FIG. 6C illustrates a temperature distribution along the lengthwise direction of the film surface in the case of printing on a small-size recording material (A6 size). Temperature measurement points on the film surface in FIGS. 6A and 6B are the positions X1 and X2 in FIG. 6C, respectively. The position X1 is the central position of the sheet-passing portion, and the position X2 is a position at which the temperature of the film surface reaches a peak. Solid lines in FIGS. 6A and 6B indicate the case of performing the power control according to the present exemplary embodiment illustrated in FIGS. 4A and 5A. Broken lines in FIGS. 6A and 6B indicate the case of performing the power control according to the comparative example illustrated in FIGS. 4B and 5B. As illustrated in FIG. 6A, warm-up time according to the present exemplary embodiment is shorter than that of the comparative example. The warm-up time is a time period needed for the temperature of the sheet passing portion of the film 11 to reach a target temperature T1, at which fixing is possible. This indicates that if power is supplied only to the heat generation resistor 305 formed on the second surface of the heater 12 after the start of the supply of power to the heater 12 as in the comparative example, it takes time for the heat of the heater 12 to transfer to the surface of the film 11. According to the present exemplary embodiment, on the other hand, since power is supplied only to the heat generation resistor 309 formed on the first surface during the period from the start of the power supply to the heater 12 to the predetermined timing, the temperature of the sheet passing portion of the film 11 increases more rapidly than in the comparative example. Further, as illustrated in FIG. 6B, there is almost no difference in the temperature of the non-sheet-passing portion during the continuous printing between the comparative example and the present exemplary embodiment. This is because the power control is switched from the first power control to the second power control according to the temperature of the non-sheet-passing portion in the present exemplary embodiment.

Table 3 shows the first print out time (FPOT) and the maximum temperature of the non-sheet-passing portion of the film 11 in the case of performing continuous printing on A6-size recording materials in the present exemplary embodiment and in the comparative example. The FPOT is the time from the input of a print job to the completion of printing on the first recording material, and the warm-up time of the fixing apparatus is likely to affect the FPOT. From Table 3, it can be understood that the power control according to the present exemplary embodiment can shorten the FPOT without adversely affecting the increase in the temperature of the non-sheet-passing portion.

TABLE 3

| | | Maximum temperature of |
|---|---|---|
| | | non-sheet-passing |
| | FPOT | portion |
| First exemplary embodiment | 5.0 sec | 210° C. |
| Comparative example | 7.5 sec | 210° C. |

As described above, the present exemplary embodiment can shorten the warm-up time of the fixing apparatus including the heater with heat generation resistors which are formed on front and back surfaces of a substrate and to which power can be independently supplied, even in the case where the heat generation resistor on the back surface of the heater is heated.

While the present exemplary embodiment describes that the predetermined timing D, which is the timing of ending the first period during which the first power control is performed, is determined according to a temperature detected by the sub-thermistor 14b. However, the timing is not limited to the present embodiment. That is, at the predetermined timing D, the heater 12 only needs to be sufficiently warmed up. Thus, the predetermined timing D may be a timing after an elapse of a predetermined time since the start of the supply of power to the heater 12.

Further, according to the present exemplary embodiment, the power control is carried out to supply power only to the heat generation resistor 309 in the first period in the case of performing the fixing process on a recording material having a width of 110 mm or less. However, the control is not limited to the exemplary embodiment. According to a first modified example of the present exemplary embodiment, in the case of performing the fixing process on a recording material having a width of 110 mm or less, power is supplied to both of the heat generation resistors 309 and 305 in the first period, and power is supplied only to the heat generation resistor 305 in the second period. In the first period, the power supplied to the heat generation resistor 305 is set to be lower than the power supplied to the heat generation resistor 309.

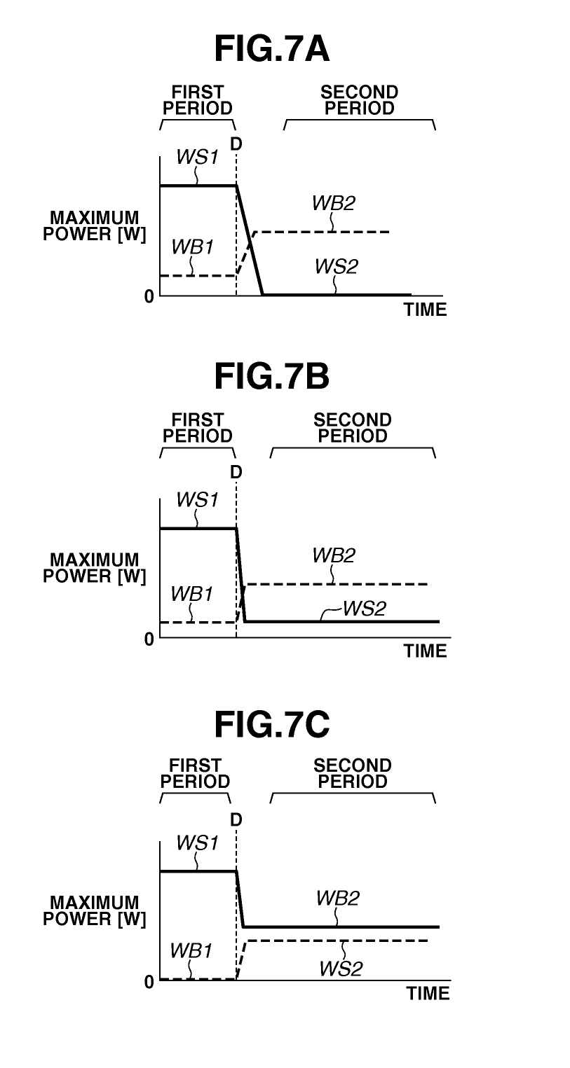

The maximum power WB1 supplied to the heat generation resistor 305 and the maximum power WS1 supplied to the heat generation resistor 309 are determined based on the ratio of the power supplied to the heat generation resistor 305 to the power supplied to the heat generation resistor 309 in the first period. Further, as illustrated in FIG. 7A, the maximum power (WB1) supplied to the heat generation resistor 305 in the first period is set smaller than the maximum power (WB2) supplied to the heat generation resistor 305 in the second period.

Next, according to a second modified example of the present exemplary embodiment, in the case of a recording material having a width of 110 mm or less, power is supplied to both of the heat generation resistors 309 and 305 in both of the first and second periods. The power supplied to the heat generation resistor 305 in the first period is set lower than the power supplied to the heat generation resistor 309 in the first period. The power supplied to the heat generation resistor 309 in the second period is set lower than the power supplied to the heat generation resistor 305 in the second period.

The ratio of the maximum power WB1 supplied to the heat generation resistor 305 to the maximum power WS1 supplied to the heat generation resistor 309 is determined based on the ratio of the power supplied to the heat generation resistor 305 in the first period to the power supplied to the heat generation resistor 309 in the first period. Similarly, the ratio of the maximum power WB2 supplied to the heat generation resistor 305 to the maximum power WS2 supplied to the heat generation resistor 309 is determined based on the ratio of the power supplied to the heat generation resistor 305 in the second period to the power supplied to the heat generation resistor 309 in the second period. Further, as illustrated in FIG. 7B, the maximum power supplied to the heat generation resistor 309 is set such that the maximum power (WS2) in the second period is lower than the maximum power (WS1) in the first period. Furthermore, the maximum power supplied to the heat generation resistor 305 is set such that the maximum power (WB1) in the first period is lower than the maximum power (WB2) in the second period.

Further, another power control may be adopted according to a third modified example. Specifically, the power control performed in the first period is similar to that in the first exemplary embodiment, and the maximum power (WS2) supplied to the heat generation resistor 309 in the second period is controlled to become higher than the maximum power (WB2) supplied to the heat generation resistor 305 in the second period.

The heater includes heat generation resistors having different lengths according to the present exemplary embodiment. However, the heater is not limited to the present embodiment. The heater may be a both-sided heater in which a heat generation area is divided into a plurality of areas in the lengthwise direction and the heat generation areas are switched and adjusted. Further, a plurality of heat generation resistors having the same length and different resistance values may be provided to switch to each other.

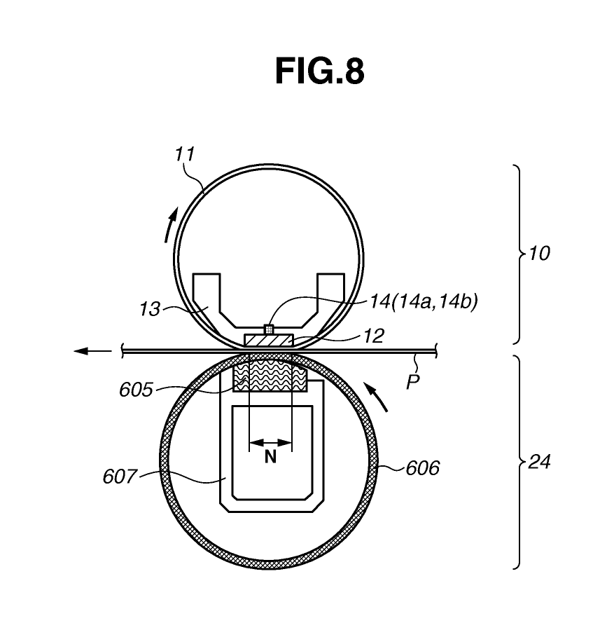

Further, the technical concept of the present exemplary embodiment is applicable to a fixing apparatus in which a pressure belt unit is provided to face the film unit 10, as illustrated in FIG. 8. The pressure belt includes a pressure belt 606, a pressure pad 605 being in contact with an inner surface of the pressure belt 606, and a pressure stay 607.

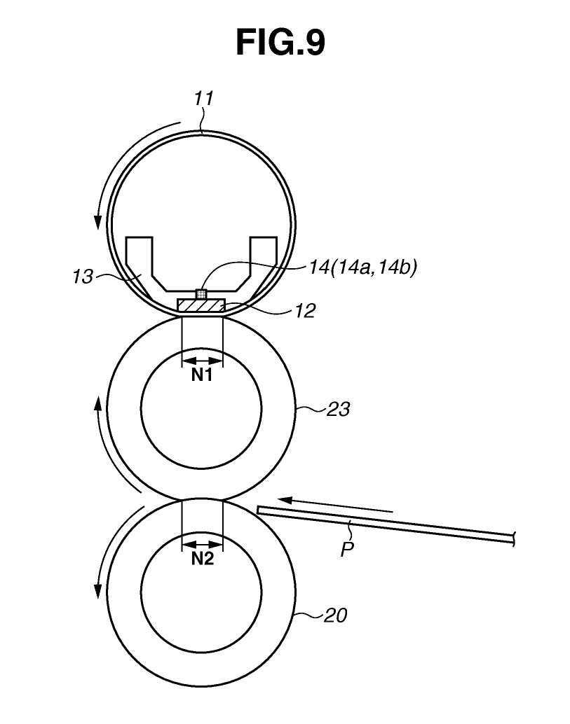

Further, according to the present exemplary embodiment, the film unit 10 forms the nip portion N for conveying a recording material between the film unit 10 and the pressure roller 20. Alternatively, as illustrated in FIG. 9, the fixing apparatus may be configured to include a heating film 11, a heater 12 contacting an inner surface of the heating film 11, a fixing roller 23, and a pressure roller 20, which forms a nip portion N2 together with the fixing roller 23. In this configuration, the heater 12 forms a heat pressure contact portion N1 together with the fixing roller 23 via the heat film 11. A surface of the fixing roller 23 is heated by heat generated by the heater 12 via the heat pressure contact portion N1.

The following describes a second exemplary embodiment of the present invention. The present exemplary embodiment is similar to the first exemplary embodiment, except for the heat generation resistors formed on front and back surfaces of the heater 12, and power control for the heater 12. In the following description, only feature points of the present exemplary embodiment will be described, and description of features that overlap a feature of the first exemplary embodiment is omitted.

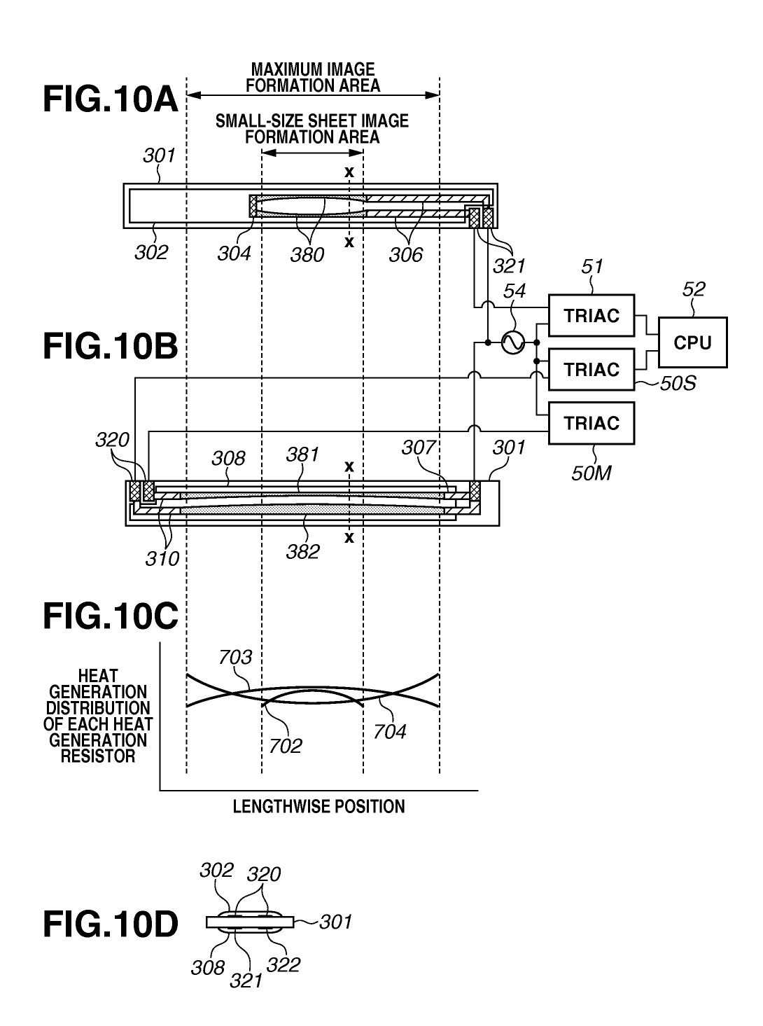

FIG. 10B is a schematic view illustrating the surface (first surface) of the heater 12 according to the present exemplary embodiment that is in contact with an inner surface of a film. FIG. 10A is a schematic view illustrating a surface (second surface) that is opposite to the first surface of the heater 12 according to the present exemplary embodiment. FIG. 10D is a schematic view illustrating a cross section of the heater 12 along the x-x′ cross section specified in FIGS. 10A and 10B.

As illustrated in FIG. 10B, a heat generation resistor 381 as a first heat generation resistor and a heat generation resistor 382 as a second heat generation resistor are formed on the first surface of the substrate 301. The heat generation resistors 381 and 382 are formed in a length of 225 mm along the lengthwise direction of the substrate 301. The heat generation resistor 381 has such a pattern that the width of the substrate 301 in the widthwise direction gradually increases from a central portion toward an end portion in the lengthwise direction of the substrate 301. The heat generation resistor 382 has a pattern that the width of the substrate 301 in the widthwise direction gradually decreases from a central portion toward an end portion in the lengthwise direction of the substrate 301. The heat generation resistors 381 and 382 have a symmetrical pattern with respect to a center of the substrate 301 in the lengthwise direction. The resistance value of the heat generation resistor 381 is 20Ω, and the resistance value of the heat generation resistor 382 is 33Ω.

Next, as illustrated in FIG. 10A, a heat generation resistor 380 as a third heat generation resistor is formed on the second surface of the substrate 301. The heat generation resistor 380 is formed in a length of 115 mm along the lengthwise direction of the substrate 301. The heat generation resistor 380 has a symmetrical pattern with respect to the center of the substrate 301 in the lengthwise direction. The heat generation resistor 380 has such a pattern that the width of the substrate 301 in the widthwise direction gradually increases from a central portion toward an end portion in the lengthwise direction of the substrate 301. The resistance value of the heat generation resistor 380 is 25Ω.

FIG. 10C illustrates heat generation distributions of the heat generation resistors 381, 382, and 380 in the lengthwise direction of the substrate 301. As illustrated in FIG. 10C, the heat generation distribution of the heat generation resistor 381 shows a heat generation distribution 703 in which the heat generation amount gradually decreases from the central portion toward the end portion in the lengthwise direction. The heat generation distribution of the heat generation resistor 382 shows a heat generation distribution 704 in which the heat generation amount gradually increases from the central portion toward the end portion in the lengthwise direction. The heat generation distribution of the heat generation resistor 380 shows a heat generation distribution 702 in which the heat generation amount gradually decreases from the central portion toward the end portion in the lengthwise direction.

The fixing apparatus according to the present exemplary embodiment can perform control to supply power to the heat generation resistors 381, 382, and 380 independently. By changing the ratio between the power supplied to the heat generation resistor 381 and the power supplied to the heat generation resistor 382, the heat generation resistors 381 and 382 can process a recording material wider than the width (110 mm), which can be processed by the heat generation resistor 380, and equal to or less than the maximum width (216 mm) of a recording material that can be conveyed by the fixing apparatus.

Further, the power supply to the heat generation resistor 380 and the power supply to the heat generation resistor 382 are controlled independently, so that the heater can process a recording material having a width that is less than the width (110 mm) of the heat generation resistor 380. That is to say, the power to the heat generation resistor 381, the power to the heat generation resistor 382, and the power to the heat generation resistor 380 are controlled independently of one another so that the heater can process a wider variety of sizes of recording materials than the heater according to the first exemplary embodiment. Moreover, an increase in the temperature of the non-sheet-passing portion can be prevented.

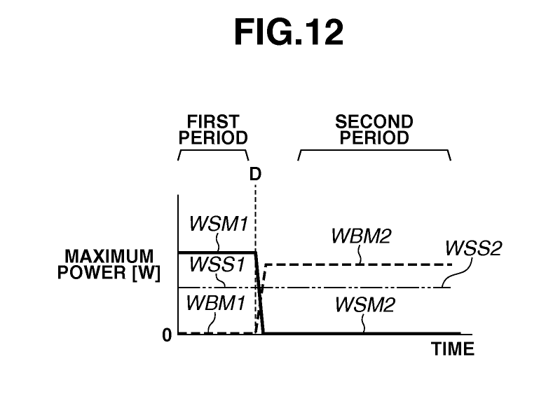

The following describes the power control performed on the heat generation resistors (381, 382, 380) of the heater 12, which is a feature of the present exemplary embodiment. First, the power control in the fixing process performed on a small-size recording material having a width of 110 mm or less will be described. Table 4 shows the maximum power supplied to each of the heat generation resistors (381, 382, 380) in the first period, which is a period from the start of the supply of power to the heater 12, to the predetermined timing (D), and the second period started following the first period. Further, FIG. 12 illustrates how the maximum power supplied to each of the heat generation resistors (381, 382, 380) is changed from the first period to the second period.

According to the present exemplary embodiment, third power control is performed in the first period to supply power only to the heat generation resistors 381 and 382 formed on the first surface contacting the inner surface of the film 11 even in the case of performing the fixing process on a small-size recording material having a width of 110 mm or less. The third power control is configured to supply power to the heat generation resistors 381 and 382 and to supply no power to the heat generation resistor 380. By performing the third power control, the film 11 can be rapidly warmed up in the first period, during which components of the fixing apparatus such as the film 11 are not presumed to be warmed up. The third power control in the first period produces an effect that the warm-up time of the fixing apparatus can be shortened. Then, in the second period started following the first period, fourth power control is performed to supply power only to the heat generation resistor 382 formed on the first surface of the heater 12 and the heat generation resistor 380 formed on the second surface. The fourth power control performs control to supply power to the heat generation resistors 382 and 380 while supplying no power to the heat generation resistor 381. By performing the fourth power control, after the film 11 is warmed up in the first period, a heat generation distribution for a small-size recording material having a width of 110 mm or less is formed and the film 11 is heated, so that an increase in the temperature of the non-sheet-passing portion can be prevented.

On the other hand, in the case of performing the fixing process on a recording material having a width exceeding 110 mm, the third power control is performed during the period from the start of the supply of power to the heater 12, to the end of the fixing process.

TABLE 4

| | First period | Second period |
|---|---|---|
| Maximum power supplied to heat | WSM1 (500 W) | WSM2 (0 W) |
| generation resistor 381 | | |
| Maximum power supplied to heat | WSS1 (300 W) | WSS2 (300 W) |
| generation resistor 382 | | |
| Maximum power supplied to heat | WBM1 (0 W) | WBM2 (400 W) |
| generation resistor 380 | | |

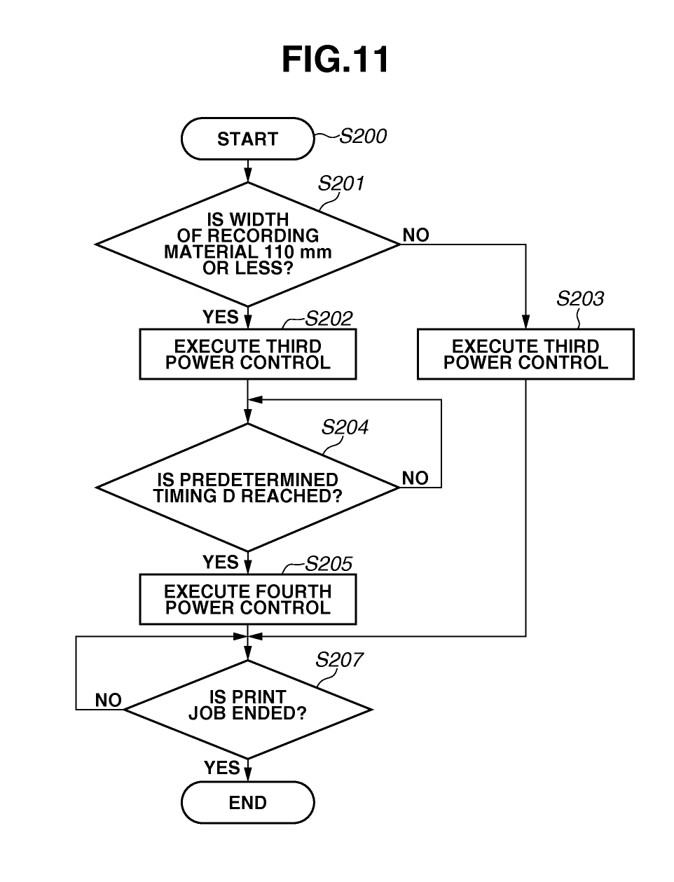

FIG. 11 is a flow chart illustrating the power control according to the present exemplary embodiment. In step S200, a print job is started. Then, in step S201, it is determined whether the recording material is a small-size recording material having a width of 110 mm or less. In step S201, if it is determined that the width of the recording material is 110 mm or less (YES in step S201), then in step S202, the third power control is performed. In step S204, if the predetermined timing D has been reached (YES in step S204), then in step S205, the power control is changed to the fourth power control. Thereafter, in step S207, the print job is ended. On the other hand, in step S201, if it is determined that the width of the recording material exceeds 110 mm (NO in step S201), then in step S203, the power control is changed to the third power control. Thereafter, in step S207, the print job is ended.

The following describes changes in the maximum power supplied to each of the heat generation resistors 381, 382, and 380 in the case of performing the fixing process on a recording material having a width of 110 mm or less in the present exemplary embodiment, with reference to FIG. 12. In the first period, since no power is supplied to the heat generation resistor 380, the maximum power (WBM1) supplied to the heat generation resistor 380 is zero. Similarly, in the second period, since no power is supplied to the heat generation resistor 381, the maximum power (WSM2) supplied to the heat generation resistor 381 is zero. Further, the maximum power (WSS1) supplied to the heat generation resistor 382 in the first period is set to be equal to the maximum power (WSS2) supplied to the heat generation resistor 382 in the second period. The maximum power WSM1 and WSS1 supplied to the heat generation resistors 381 and 382, respectively, in the first period are determined based on the ratio of the power supplied between the heat generation resistor 381 and the power to be supplied to the heat generation resistor 382. The ratio is determined according to the size of the recording material, etc. Similarly, the maximum power WSS2 and WBM2 supplied to the heat generation resistors 382 and 380, respectively, in the second period are determined based on the ratio of the power supplied to the heat generation resistor 382 and the power supplied to the heat generation resistor 380. The ratio is determined according to the size of the recording material, etc.

Table 5 illustrates the FPOT and the maximum temperature of the non-sheet-passing portion of the film 11 in the case of performing continuous printing on A6 size recording materials in the present exemplary embodiment and in the comparative example described in the first exemplary embodiment. From Table 5, it can be understood that the power control according to the present exemplary embodiment can shorten the FPOT without adversely affecting the increase in the temperature of the non-sheet-passing portion.

TABLE 5

| | | Maximum temperature of |
|---|---|---|
| | | non-sheet-passing |
| | FPOT | portion |
| Second exemplary embodiment | 5.0 sec | 200° C. |
| Comparative example | 7.5 sec | 210° C. |

As described above, according to the present exemplary embodiment, the warm-up time of the fixing apparatus can be shortened even in a case where the heat generation resistor on the back surface of the heater is heated. The fixing apparatus includes the heater having the heat generation resistors formed on front and back surfaces of the substrate, to which power can be independently supplied.

According to the present exemplary embodiment, the predetermined timing D, which is a timing to end the first period in which the first power control is performed, is determined according to a temperature detected by the sub-thermistor 14b. However, the timing is not limited to the present embodiment. At the predetermined timing D, the heater 12 only needs to be sufficiently warmed. Thus, the predetermined timing D may be a timing after an elapse of a predetermined time since the start of the power supply to the heater 12.

According to the present exemplary embodiment, the control is performed to supply power only to the heat generation resistors 381 and 382 formed on the first surface contacting the inner surface of the film 11. Alternatively, power may be supplementarily supplied to the heat generation resistor 380 in the first period. In this case, the total power supplied to the heat generation resistors 381 and 382 is set to be higher than the power supplied to the heat generation resistor 380.

Further, while power is supplied to both of the heat generation resistors 382 and 380 in the second period according to the present exemplary embodiment, control may be performed to supply power to at least one of the heat generation resistors 382 and 380.

While the present invention has been described with reference to exemplary embodiments, it is to be understood that the invention is not limited to the disclosed exemplary embodiments.

This application claims the benefit of Japanese Patent Application No. 2014-148109, filed Jul. 18, 2014, which is hereby incorporated by reference herein in its entirety.

What is claimed is:

1. A fixing apparatus configured to fix a toner image to a recording material, the fixing apparatus comprising:
a cylindrical film;
a heater arranged to contact an inner surface of the film, the heater including a substrate, a first heat generation resistor formed on a first surface of the substrate which is a surface facing the inner surface of the film, and a second heat generation resistor formed on a second surface of the substrate which is a surface opposite to the first surface;
a back-up member contacting the film to form a pressure contact portion; and
a control portion configured to control the power supply to the heater so as to supply power to the first heat generation resistor and to the second heat generation resistor independently,
wherein a recording material is heated by heat of the film to fix the toner image to the recording material, and
wherein during a time period from the start of warm-up of the fixing apparatus to a predetermined time, the control portion is configured either to supply power to the first heat generation resistor while supplying no power to the second heat generation resistor or to supply power to the first heat generation resistor and the second heat generation resistor such that the power supplied to the first heat generation resistor is higher than the power supplied to the second heat generation resistor.

2. The fixing apparatus according to claim 1, wherein the control portion is configured to operate such that the maximum power supplied to the first heat generation resistor is lower in a second time period than in a first time period, the first time period being the time period from the start of warm-up of the fixing apparatus to the predetermined time and the second time period being a period after the first time period, and
wherein maximum power supplied to the second heat generation resistor is higher in the second time period than in the first time period.

3. The fixing apparatus according to claim 2, wherein, during the second time period, the control portion is configured either to supply power to the second heat generation resistor while supplying no power to the first heat generation resistor or to supply power to the first heat generation resistor and to the second heat generation resistor such that the power supplied to the second heat generation resistor is higher than the power supplied to the first heat generation resistor.

4. The fixing apparatus according to claim 1, further comprising a temperature detector configured to detect the temperature of an end portion of the heater in a generatrix direction,
wherein the predetermined time is a time at which the temperature detected by the temperature detector reaches a predetermined temperature.

5. The fixing apparatus according to claim 1, wherein the heat generation resistors are configured such that, in a generatrix direction of the film, an amount of heat generation in an end portion of the first heat generation resistor is larger than an amount of heat generation in a central portion of the first heat generation resistor, and an amount of heat generation in an end portion of the second heat generation resistor is smaller than an amount of heat generation in a central portion of the second heat generation resistor.

6. The fixing apparatus according to claim 1, wherein a length of the first heat generation resistor in a generatrix direction of the film is longer than a length of the second heat generation resistor.

7. The fixing apparatus according to claim 1, wherein, in a case where a fixing process is performed on a recording material having a width narrower than a maximum width of a recording material conveyable by the fixing apparatus, during the time period from the start of warm-up of the fixing apparatus to the predetermined time, the control portion is configured either to supply power to the first heat generation resistor while supplying no power to the second heat generation resistor or to supply power to the first heat generation resistor and the second heat generation resistor such that the power supplied to the first heat generation resistor is higher than the power supplied to the second heat generation resistor.

8. The fixing apparatus according to claim 1, wherein the pressure contact portion is a nip portion at which a recording material is conveyed.

9. The fixing apparatus according to claim 1, wherein the heater forms a nip portion together with the back-up member via the film.

10. A fixing apparatus configured to fix a toner image to a recording material, the fixing apparatus comprising:
a cylindrical film;
a heater arranged to contact an inner surface of the film and including a substrate, first and second heat generation resistors formed on a first surface of the substrate which is a surface facing the inner surface of the film, and a third heat generation resistor formed on a second surface of the substrate which is a surface opposite to the first surface;
a back-up member contacting the film to form a pressure contact portion; and
a control portion configured to control the power supply to the heater so as to supply power to the first heat generation resistor, to the second heat generation resistor, and to the third heat generation resistor independently,
wherein a recording material is heated by heat of the film to fix the toner image to the recording material, and
wherein during a time period from a start of warm-up of the fixing apparatus to a predetermined time, the control portion is configured either to supply power to at least one of the first heat generation resistor and the second heat generation resistor while supplying no power to the third heat generation resistor or to supply power to the first heat generation resistor, the second heat generation resistor, and the third heat generation resistor such that a total of the power supplied to the first heat generation resistor and the power supplied to the second heat generation resistor is higher than the power supplied to the third heat generation resistor.

11. The fixing apparatus according to claim 10, wherein the heat generation resistors are configured such that, in a generatrix direction of the film, an amount of heat generation in an end portion of the first heat generation resistor is larger than an amount of heat generation in a central portion of the first heat generation resistor, an amount of heat generation in an end portion of the second heat generation resistor is smaller than an amount of heat generation in a central portion of the second heat generation resistor, and an amount of heat generation in an end portion of the third heat generation resistor is smaller than an amount of heat generation in a central portion of the third heat generation resistor.

12. The fixing apparatus according to claim 10, wherein during a second time period, the control portion is configured to supply power to the first heat generation resistor and the third heat generation resistor while supplying no power to the second heat generation resistor, the first time period being the time period from the start of warm-up of the fixing apparatus to the predetermined time and the second time period being a time period after the first time period.

13. The fixing apparatus according to claim 10, further comprising a temperature detector configured to detect the temperature of an end portion of the heater in a generatrix direction,
wherein the predetermined time is a time at which the temperature detected by the temperature detector reaches a predetermined temperature.

14. The fixing apparatus according to claim 10, wherein the pressure contact portion is a nip portion at which a recording material is conveyed.
